(19) United States
(12) Patent Application Publication
(10) Pub. No.: US 2006/0180127 A1
(43) Pub. Date: Aug. 17, 2006

(54) Canister module and method for absorbing volatile substance

(75) Inventors: Noboru Hirano, Kariya -city (JP); Nobuhiko Koyama, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/346,444

(22) Filed: Feb. 3, 2006

(30) Foreign Application Priority Data
Feb. 15, 2005 (JP) 2005-37679

(51) Int. Cl. F02M 25/08

(52) U.S. Cl. 123/520

(57) ABSTRACT

A canister module includes a canister, an atmospheric passage member, and an absorbent layer. The canister accommodates an absorbent for absorbing volatile substance. The atmospheric passage member forms an atmospheric passage, which has a first end connecting with the canister. The atmospheric passage has a second end, which is an open end that opens to atmosphere. The absorbent layer is arranged along an inner wall of the atmospheric passage member substantially in a circumferential direction of the atmospheric passage member. The absorbent layer absorbs volatile substance that passes through the atmospheric passage member after passing through the canister.

### CROSS REFERENCE TO RELATED APPLICATIONS

This application is based on and incorporates herein by reference Japanese Patent Applications No. 2005-37679 filed on Feb. 15, 2005.

### FIELD OF THE INVENTION

The present invention relates to a canister module that absorbs volatile substance. More particularly, the present invention relates to a canister module that absorbs fuel vaporized in a fuel tank. The present invention further relates to a method for absorbing volatile substance.

### BACKGROUND OF THE INVENTION

Conventionally, a canister absorbs volatile substance such as fuel vaporized in a fuel tank. The canister includes absorbent such as activated charcoal for absorbing fuel vapor, thereby reducing emission of fuel vapor. However, fuel vapor may partially diffuse from the canister to the atmosphere. According to JP-A-9-21361 (U.S. Pat. No. 5,743,943), a passage in the canister forms a labyrinth, so that the total length of the passage is extended for restricting fuel vapor from diffusing to the atmosphere. In this structure, the length of the passage, in which fuel vapor diffuses, is extended, so that fuel vapor can be restricted from being emitted to the atmosphere. According to JP-A-2002-30998 (U.S. Pat. No. 6,460,516), a canister has a space on the side, on which the canister opens to the atmosphere. In this structure, an absorbent layer is provided in the space of the canister.

However, in the structure of U.S. Pat. No. 5,743,943, the passage needs to be formed in an air chamber of the canister. Accordingly, the casing of the canister needs to be blocked with a lid. The lid is welded to the casing, consequently the structure of the canister may be complicated, and manpower for manufacturing work of the canister may be increased.

By contrast, in the structure of U.S. Pat. No. 6,460,516, the absorbent layer is arranged perpendicularly with respect to the direction, in which air flows in a passage communicating to the atmosphere. As a result, air resistance increases in the passage, and pressure drop of airflow increases in the passage. Furthermore, in the structure of U.S. Pat. No. 6,460,516, a necessary and sufficient amount of absorbent and a supporting member for holding the absorbent are needed for absorbing fuel vapor passing through the canister. Therefore, the structure may be complicated, and the number of components may be increased.

### SUMMARY OF THE INVENTION

In view of the foregoing and other problems, it is an object of the present invention to produce a canister module that has a simple structure being capable of restricting volatile substance from being emitted to the atmosphere, while reducing pressure drop in a passage therein. It is another object of the present invention to produce a method for further absorbing volatile substance using a canister.

According to one aspect of the present invention, a canister module includes a canister, an atmospheric passage member, and an absorbent layer. The canister accommodates an absorbent for absorbing volatile substance. The atmospheric passage member forms an atmospheric passage, which has a first end connecting with the canister. The atmospheric passage has a second end, which is an open end that opens to atmosphere. The absorbent layer is arranged along an inner wall of the atmospheric passage member substantially in a circumferential direction of the atmospheric passage member. The absorbent layer absorbs volatile substance that passes through the atmospheric passage member after passing through the canister.

Alternatively, a canister module connects with a fuel tank. The canister module includes a canister, an atmospheric passage member, and an absorbent layer. The canister accommodates an absorbent. The atmospheric passage member has a first end, which is capable of communicating with an atmospheric port of the canister. The atmospheric passage member has a second end that is capable of communicating with atmosphere. The fuel tank communicates with the atmospheric port of the canister through the absorbent accommodated in the canister. The absorbent layer is arranged along an inner wall of the atmospheric passage member. The fuel tank communicates with the absorbent layer accommodated in the atmospheric passage member through the absorbent accommodated in the canister when the atmospheric passage member communicates with the atmospheric port of the canister.

In this structure, the canister module may connect with an intake pipe of an internal combustion engine. In this case, the intake pipe communicates with the absorbent layer accommodated in the atmospheric passage member through the absorbent accommodated in the canister when the following conditions are satisfied. First, the intake pipe communicates with the canister. Second, the atmospheric passage member communicates with the atmospheric port of the canister.

A method for absorbing volatile substance includes the following steps. A canister and an atmospheric passage member are provided. The canister accommodates an absorbent. The atmospheric passage member connects with the canister. The atmospheric passage member is capable of communicating with atmosphere. The atmospheric passage member accommodates an absorbent layer that is arranged along an inner wall of the atmospheric passage member. Volatile substance is introduced into the canister for absorbing volatile substance in the canister. Volatile substance is introduced from the canister into the atmospheric passage member for further absorbing volatile substance through the atmospheric passage member.

A manufacturing method of a canister module includes the following steps. At least one absorbent layer is inserted into an atmospheric passage member from one of a first end of the atmospheric passage member and a second end of the atmospheric passage member such that the absorbent layer is arranged along an inner wall of the atmospheric passage member. One of the first end of the atmospheric passage member and the second end of the atmospheric passage member is connected to a first component. The other of the first end of the atmospheric passage member and the second end of the atmospheric passage member is connected to a second component. The first component is one of a canister, which is adapted to accommodate an absorbent, a drain valve, which is capable of communicating and blocking the atmospheric passage member, and a filter, which is capable of removing foreign matters. The second component is one of the other of the canister, the drain valve, and the filter.

Thus, volatile substance, which is introduced from the canister into the atmospheric passage member can be further absorbed through the absorbent layer in the atmospheric passage member.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing an evaporated fuel processing apparatus that has a canister module according to a first embodiment of the present invention;

FIG. 2 is a cross sectional view taken along the line II-II in FIG. 1;

FIG. 3 is a schematic view showing an evaporated fuel processing apparatus that has a canister module according to a second embodiment of the present invention;

FIG. 4 is a cross sectional view showing an absorbent layer of an evaporated fuel processing apparatus having a canister module, according to a first embodiment of the present invention;

FIG. 5 is a schematic view showing an evaporated fuel processing apparatus that has a canister module according to a fourth embodiment of the present invention; and

FIG. 6 is a cross sectional view taken along the line VI-VI in FIG. 5.

### DETAILED DESCRIPTION OF PREFERRED EMBODIMENTS

### First Embodiment

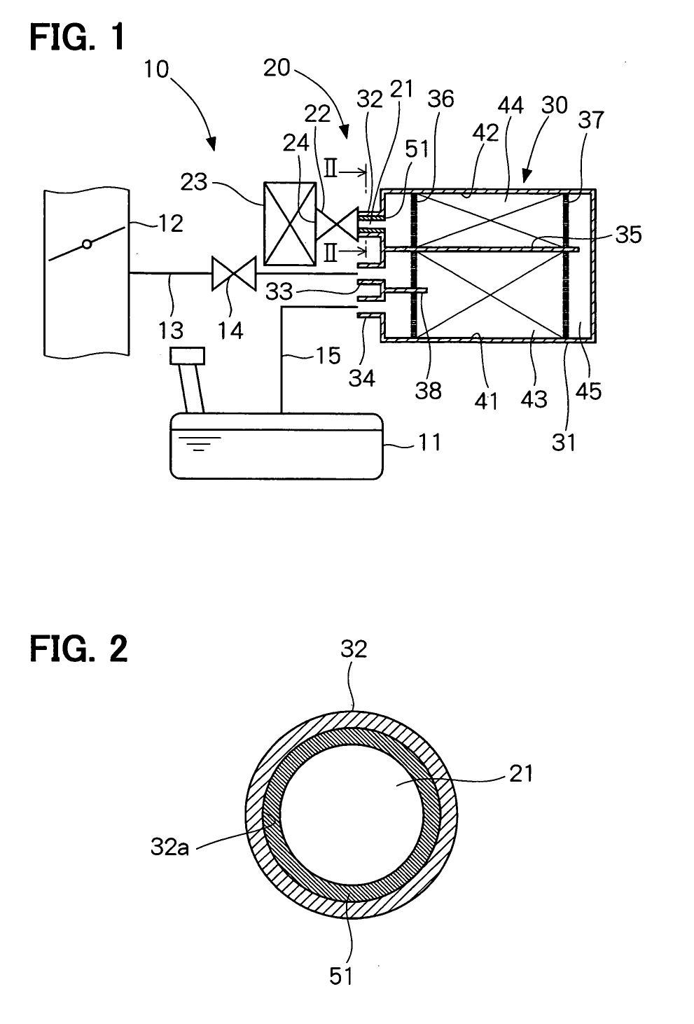

As shown in FIG. 1, a fuel vapor processing apparatus 10 introduces fuel vaporized in a vehicular fuel tank 11 into an intake pipe 12 of an internal combustion engine (not shown). The fuel vapor processing apparatus 10 includes a canister module 20 and a purge valve 14. The purge valve 14 is provided in a purge passage 13. The fuel vapor processing apparatus 10 may include another component such as a concentration detecting device and a leakage detecting device, in addition to the canister module 20 and the purge valve 14. The concentration detecting device detects concentration of fuel vapor. The leakage detecting device detects leakage of fuel vapor.

The canister module 20 includes a canister 30, a drain valve 22, and an atmospheric filter 23. The canister 30 has a casing 31 that is formed of metal, resin, or the like. The casing 31 serves as a receiver. The casing 31 includes an atmospheric port 32, a purge port 33, and a tank port 34. The atmospheric port 32 serves as an atmospheric passage member that forms an atmospheric passage 21. The purge port 33 connects with an the intake pipe 12 through the purge passage 13. The tank port 34 connects with the fuel tank 11 through the tank passage 15. The canister 30 has a first accommodation chamber 41 and a second accommodation chamber 42 that are partitioned using a partitioning portion 35, and a supporting plates 36, 37. The partitioning portion 35 is integrally formed with the casing 31. The first accommodation chamber 41 receives an absorbent 43. The second accommodation chamber 42 receives an absorbent 44. The absorbents 43, 44 are formed of a porous material such as activated charcoal and silica gel. The first accommodation chamber 41 communicates with the purge port 33 and the tank port 34. The second accommodation chamber 42 communicates with the atmospheric port 32. The supporting plates 36, 37 respectively have a number of through holes that penetrates the supporting plates 36, 37 in the thickness direction thereof, thereby allowing air flowing into the first and second accommodation chambers 41, 42. In addition, the supporting plates 36, 37 protect the absorbents received in the first and second accommodation chambers 41, 42 from collapsing.

The first and second accommodation chambers 41, 42 communicate with each other through a communication passage 45 that is defined by the casing 31 and the supporting plate 37.

The space in the casing 31 on the opposite side of the first accommodation chamber 41 with respect to the communication passage 45 is partitioned into a chamber on the side of the purge port 33 and a chamber on the side of the tank port 34 via a partitioning portion 38. In this structure, fuel vapor is introduced from the fuel tank 11 into the canister 30 through the tank port 34, and the fuel is further introduced from the canister 30 into the absorbent 43 received in the first accommodation chamber 41, without shortcutting from the tank port 34 into the purge port 33 bypassing the absorbent 43.

The canister 30 communicates with the intake pipe 12 through the purge port 33 and the purge passage 13. The purge passage 13 has a purge valve 14. The purge valve 14 opens and closes the purge passage 13, thereby controlling an amount of air, which contains fuel vapor, flowing from the canister 30 into the intake pipe 12.

In this embodiment, the atmospheric port 32 of the canister 30 forms the atmospheric passage 21. For example, the atmospheric passage 21 may be constructed of a pipe member, which connects the atmospheric port 32 with the drain valve 22, and a pipe member, which connects with the drain valve 22 with the atmospheric filter 23. The atmospheric passage 21 serves as an open end 24 that opens to the atmosphere through the drain valve 22. The open end 24 is on the opposite side of the canister 30 with respect to the drain valve 22. The open end 24 has the atmospheric filter 23 that removes foreign matters contained in air introduced into the atmospheric passage 21. The drain valve 22 opens and closes the atmospheric passage 21. The drain valve 22 can block the atmospheric passage 21 for checking leakage of fuel vapor flowing from the fuel tank 11, for example.

In this embodiment, the atmospheric port 32 has an absorbent layer 51. As shown in FIG. 2, the absorbent layer 51 is in a substantially cylindrical shape. The absorbent layer 51 is arranged along the circumferential direction of an inner wall 32a of the atmospheric port 32 all around with respect to the circumferential direction of the inner wall 32a. The absorbent layer 51 is formed of activated charcoal fiber, for example, to be in a substantially cylindrical shape. The absorbent layer 51 is press-inserted into or attached into the inner periphery of the atmospheric port 32. The absorbent layer 51 may be formed of an absorbent material such as activated charcoal or silica gel, and may be directly adhered to the inner wall 32a of the atmospheric port 32.

Next, an operation of the fuel vapor processing apparatus 10 is described.

As referred to FIG. 1, as fuel is vaporized in the fuel tank 11, pressure in the fuel tank 11 increases, so that air containing fuel vapor flows from the fuel tank 11 into the canister 30. When the engine stops, the drain valve 22 opens, so that the atmospheric passage 21 communicates with the atmosphere. As pressure in the fuel tank 11 increases, the air flowing out of the fuel tank 11 is discharged from the open end 24 of the atmospheric passage 21 through the canister 30. In this condition, fuel vaporized in the fuel tank 11 is introduced into the first accommodation chamber 41 of the canister 30 through the tank passage 15 and the tank port 34. Thus, most part of the fuel vapor is absorbed by the absorbent 43 in the first accommodation chamber 41. Air flows through the first accommodation chamber 41, and enters into the second accommodation chamber 42 through the communication passage 45. Thus, fuel vapor contained in air can be further absorbed into the absorbent 44 in the second accommodation chamber 42.

When the open end 24 of the atmospheric passage 21 opens to the atmosphere, fuel vapor absorbed into the absorbent 44 in the second accommodation chamber 42 may diffuse into the atmospheric passage 21. The amount of fuel vapor, which diffuses from the absorbent 44 in the second accommodation chamber 42 into the atmospheric passage 21, may be small. However, in recent years, an amount of fuel vapor emitted to the atmosphere is strictly regulated. Therefore, fuel vapor, which flows from the absorbent 44 in the second accommodation chamber 42 into the atmospheric passage 21, needs to be further removed. In this embodiment, the absorbent layer 51 is provided to the inner wall 32a of the atmospheric port 32. Fuel vapor, which diffuses from the canister 30, is slow in diffusing speed, and is small in amount. Therefore, the absorbent layer 51 can absorb fuel vapor flowing from the second accommodation chamber 42 into the atmospheric passage 21. Thus, fuel vapor can be restricted from being emitted into the atmosphere from the atmospheric passage 21, even when the open end 24 of the atmospheric passage 21 communicates with the atmosphere.

By contrast, when the engine is operated, intake air flows through the intake pipe 12, so that suction pressure is applied to the intake pipe 12, and the interior of the canister 30 decreases in pressure. In this condition, the drain valve 22 opens, so that air is introduced from the open end 24 into the canister 30 through the atmospheric passage 21. Air introduced into the atmospheric passage 21 flows from the purge port 33 into the purge passage 13 after passing through the atmospheric passage 21, which is formed in the atmospheric port 32, the second accommodation chamber 42, the communication passage 45, and the first accommodation chamber 41. Air passes through the atmospheric passage 21, the second accommodation chamber 42, and the first accommodation chamber 41, so that fuel vapor, which is absorbed into the absorbent layer 51 and the absorbents 43, 44, can be removed from the absorbent layer 51 and the absorbents 43, 44. The fuel vapor, which is removed from the absorbent layer 51 and the absorbents 43, 44, flows into the purge passage 13 together with air introduced from the atmospheric passage 21. The purge valve 14 communicates the purge passage 13, and blocks the purge passage 13 to control an amount of air, which contains fuel vapor, flowing from the purge passage 13 into the intake pipe 12. Air, which flows from the canister 30 into the intake pipe 12 through the purge passage 13, contains fuel vapor, which is high in concentration. Therefore, the purge valve 14 controls an amount of air, which is introduced from the canister 30 and is mixed with intake air, for maintaining the air fuel ratio of intake air flowing into the engine at a predetermined value. Fuel vaporized in the fuel tank 11 is introduced into the first accommodation chamber 41 after passing through the tank passage 15 and the tank port 34. The fuel vapor introduced into the first accommodation chamber 41 flows to the purge passage 13.

In this embodiment, the absorbent layer 51 is provided in the atmospheric port 32. The absorbent layer 51 absorbs a small amount of fuel diffusing from the absorbent 44 in the second accommodation chamber 42. Thus, when the open end 24 of the atmospheric passage 21 communicates with the atmosphere, fuel vapor diffusing from the second accommodation chamber 42 of the canister 30 can be absorbed into the absorbent layer 51. Therefore, fuel vapor can be restricted from being emitted to the atmosphere.

Furthermore, in this embodiment, the absorbent layer 51 is arranged along the inner wall 32a of the atmospheric port 32 substantially in the substantially circumferential direction. Therefore, the atmospheric passage 21 can secure a sufficient cross sectional area, through which air passes, therein. Thus, air passing through the atmospheric port 32 can be restricted from being interfered by the absorbent layer 51. Therefore, pressure drop in the atmospheric passage 21 can be restricted from increasing. In addition, the atmospheric port 32 need not be jumboized for securing the cross sectional area of the atmospheric passage 21. Furthermore, the absorbent layer 51 is arranged in the atmospheric port 32 of the canister 30, so that a portion for accommodating the absorbent layer 51 need not be additionally provided. Therefore, the canister module 20 can be small sized, so that mountability of the canister module 20 can be enhanced.

Furthermore, in this embodiment, the absorbent layer 51 can be arranged along the inner wall 32a of the atmospheric port 32. When the canister 30 is assembled to the drain valve 22, the atmospheric port 32 opens on the side of the drain valve 22 before the canister 30 is connected with the drain valve 22. Therefore, the absorbent layer 51 can be readily assembled from the end of the atmospheric port 32 into the interior of the atmospheric port 32. The absorbent layer 51 is adhered with or press-inserted into the atmospheric port 32, so that the absorbent layer 51 is fixed to the atmospheric port 32. Furthermore, the atmospheric port 32 is integrally formed with the casing 31 of the canister 30. Therefore, the structure of the canister 30 can be restricted from becoming complicated, and the number of components of the canister 30 can be restricted from increasing.

### Second Embodiment

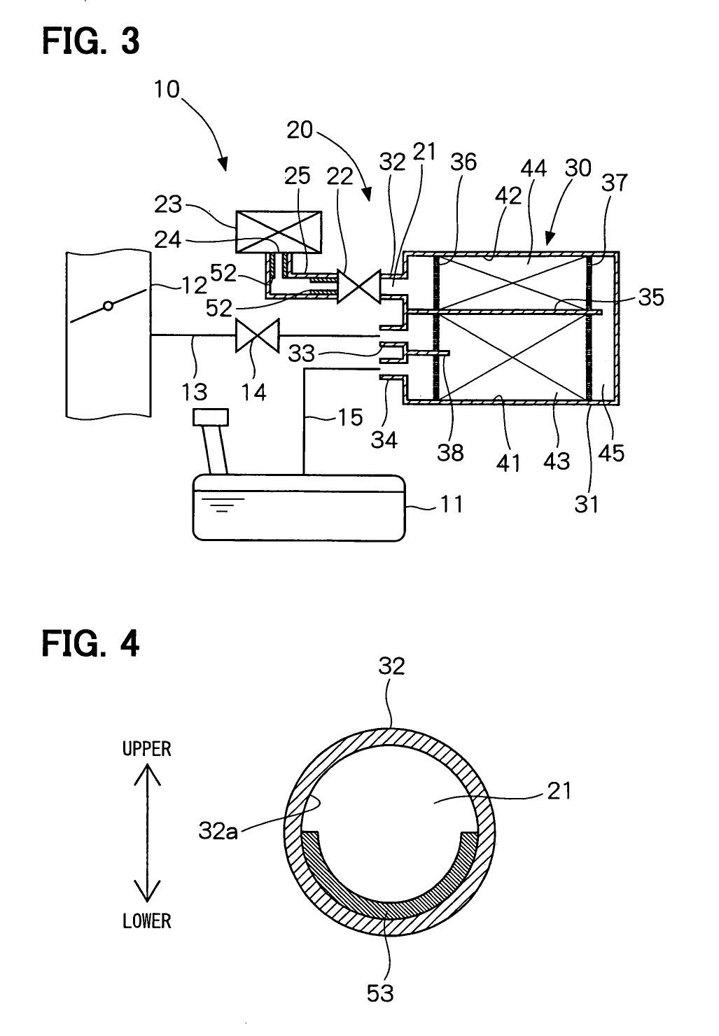

As shown in FIG. 3, in the second embodiment, the canister module 20 has the pipe member 25 that serves as an atmospheric passage member, which forms the atmospheric passage 21. The pipe member 25 connects the drain valve 22 with the atmospheric filter 23. At least one absorbent layer 52 is provided to the pipe member 25. Specifically, one absorbent layer 52 may be provided to one of the end of the pipe member 25 on the side of the drain valve 22 and the end of the pipe member 25 on the side of the atmospheric filter 23. Alternatively, one absorbent layer 52 may be provided to the end of the pipe member 25 on the side of the drain valve 22, and another absorbent layer 52 may be provided to the end of the pipe member 25 on the side of the atmospheric filter 23.

In this embodiment, the absorbent layer 52 is located to be apart from the canister 30. As fuel vapor diffuses from the absorbent 44 in the second accommodation chamber 42, and moves away from the canister 30, the fuel vapor becomes slow in diffusing speed, and becomes small in concentration with respect to air. Therefore, the absorbent layer 52 is located to be apart form the canister 30, so that efficiency of absorbing fuel vapor contained in air flowing through the atmospheric passage 21 can be enhanced. Thus, fuel vapor can be further restricted from being emitted to the atmosphere.

Furthermore, in this embodiment, the absorbent layer 52 is provided to the end of the pipe member 25. When the pipe member 25 is assembled to the drain valve 22 and the atmospheric filter 23, the pipe member 25 opens through both ends thereof before the pipe member 25 is connected with the drain valve 22 and the atmospheric filter 23. Therefore, the at least one of the absorbent layers 52 can be readily assembled from one of the ends of the pipe member 25 into the interior of the pipe member 25. Thus, the structure of the canister 30 can be restricted from becoming complicated, and the number of components of the canister 30 can be restricted from increasing.

### Third Embodiment

As shown in FIG. 4, in the third embodiment, the location of an absorbent layer 53 is different from that in the first embodiment. In this embodiment, the absorbent layer 53 is arranged on the lower side with respect to the direction of gravitational force in the atmospheric port 32. The absorbent layer 53 is in a substantially arc shape. That is, the absorbent layer 53 is arranged along the inner wall 32a of the atmospheric port 32 partially along the circumferential direction of the atmospheric port 32 to be in the substantially arc shape. The relative density of fuel vapor is greater than that of air, so that fuel vapor diffusing from the canister 30 into the atmospheric passage 21 is apt to be accumulated in the atmospheric passage 21 on the lower side with respect to the direction of gravitational force. Therefore, the absorbent layer 53 is arranged in the atmospheric port 32 on the lower side with respect to the direction of gravitational force, so that fuel vapor diffusing through the atmospheric port 32 can be effectively absorbed into the absorbent layer 53. Thus, fuel vapor can be restricted from being emitted to the atmosphere.

Furthermore, in this embodiment, the absorbent layer 53 is arranged in the portion of the atmospheric port 32 with respect to the circumferential direction of the atmospheric port 32. Therefore, in this structure, the canister 30 can be downsized, compared with a structure, in which the absorbent layer 53 is arranged all around with respect to the circumferential direction of the atmospheric port 32. Thus, the structure of the canister 30 can be further simplified, so that manufacturing cost of the canister 30 can be reduced.

### Fourth Embodiment

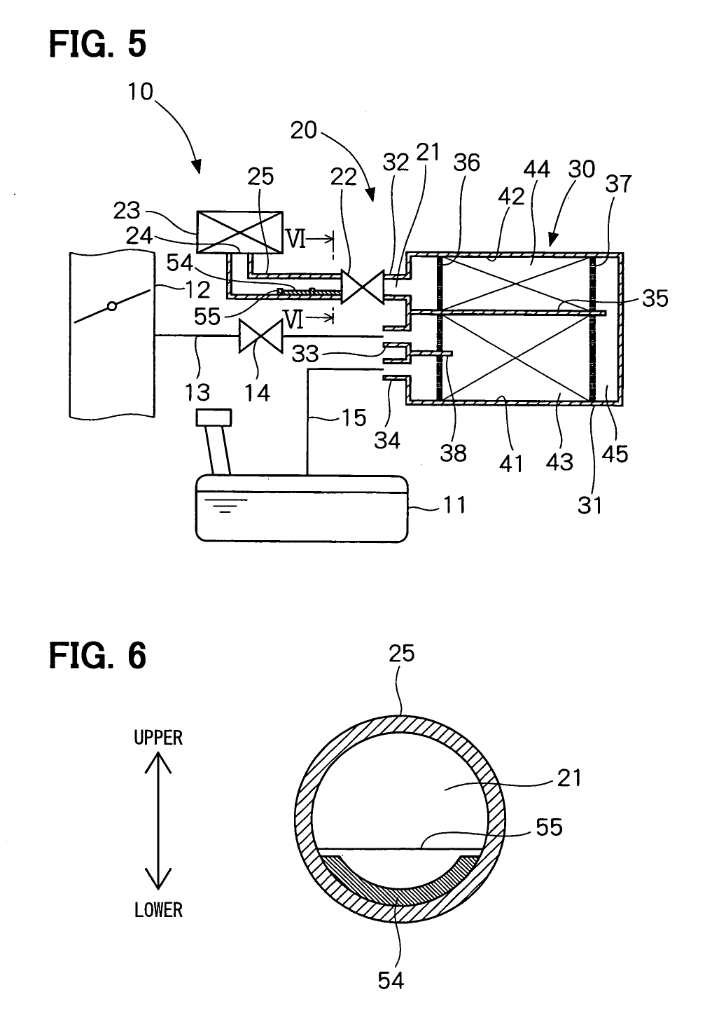

As shown in FIGS. 5, 6, an absorbent layer 54 is provided to the pipe member 25. In this embodiment, the absorbent layer 54 is located on the lower side with respect to the direction of gravitational force in the pipe member 25, similarly to the third embodiment. Furthermore, the absorbent layer 54 has weir portions 55. One of the weir portions 55 is located in the end of the absorbent layer 54 on the side of the open end 24 of the atmospheric passage 21. As shown in FIG. 6, the weir portion 55 protrudes inwardly from the absorbent layer 54 in the radial direction of the pipe member 25. As described above, fuel vapor diffusing from the absorbent 44 in the second accommodation chamber 42 of the canister 30 is apt to accumulate on the lower side of the pipe member 25 with respect to the direction of gravitational force. Fuel vapor diffuses to the open end 24 through the atmospheric passage 21. The weir portion 55 is provided to the end of the absorbent layer 54 on the side of the open end 24. In this structure, fuel vapor, which diffuses along the wall surface of the pipe member 25 on the lower side with respect to the direction of gravitational force, can be restricted from diffusing to the side of the open end 24 by the weir portion 55. The fuel vapor, which is restricted from diffusing using the weir portion 55, moves to the side of the absorbent layer 54, which is located on the lower side of the weir portion 55. As a result, the fuel vapor can be efficiently absorbed into the absorbent layer 54.

In this embodiment, fuel vapor is blocked from diffusing using the weir portion 55. Therefore, fuel vapor can be further effectively restricted from diffusing to the atmosphere.

In this embodiment, two of the absorbent layers 54 are arranged to be adjacent to each other in the axial direction of the pipe member 25, as an example. In this structure, each absorbent layer 54 has the weir portion 55 on the end thereof on the side of the open end 24. However, the number of the absorbent layer 54 is not limited to two, and may be one or at least three. When two or more absorbent layers 54 and the weir portions 55 are provided, the combination of the absorbent layer 54 and the weir portion 55 may be spaced from another combination of the absorbent layer 54 and the weir portion 55.

The above embodiments can be appropriately combined with each other. For example, the absorbent layer 51 in the first embodiment may be combined with the weir portion 55 in the fourth embodiment.

Various modifications and alternations may be diversely made to the above embodiments without departing from the spirit of the present invention.

What is claimed is:

1. A canister module comprising:
a canister that accommodates an absorbent for absorbing volatile substance;
an atmospheric passage member that forms an atmospheric passage, which has a first end connecting with the canister, the atmospheric passage having a second end, which is an open end that opens to atmosphere; and
an absorbent layer that is arranged along an inner wall of the atmospheric passage member substantially in a circumferential direction of the atmospheric passage member, the absorbent layer absorbing volatile substance that passes through the atmospheric passage member after passing through the canister.

2. The canister module according to claim 1, further comprising:
a drain valve that is capable of communicating the atmospheric passage therethrough, the drain valve being capable of blocking the atmospheric passage,
wherein the absorbent layer is arranged between the canister and the drain valve.

3. The canister module according to claim 1, further comprising:
a drain valve that is capable of communicating the atmospheric passage therethrough, the drain valve being capable of blocking the atmospheric passage; and
an atmospheric filter that is provided to the open end, wherein the absorbent layer is arranged between the drain valve and the atmospheric filter.

4. The canister module according to claim 1, wherein the absorbent layer is arranged along the inner wall of the atmospheric passage member all around with respect to a circumferential direction of the atmospheric passage member.

5. The canister module according to claim 1, wherein the absorbent layer is arranged in a portion of the inner wall of the atmospheric passage member with respect to a circumferential direction of the atmospheric passage member along the inner wall of the atmospheric passage member.

6. The canister module according to claim 5, wherein the absorbent layer is arranged on a lower side with respect to a direction of gravitational force.

7. The canister module according to claim 4,
wherein the absorbent layer includes an end that has a weir portion on a side of the open end, and
the weir portion protrudes inwardly with respect to a radial direction of the atmospheric passage member.

8. The canister module according to claim 5,
wherein the absorbent layer includes an end that has a weir portion on a side of the open end, and
the weir portion protrudes inwardly with respect to a radial direction of the atmospheric passage member.

9. The canister module according to claim 5,
wherein the absorbent layer is arranged on a lower side with respect to a direction of gravitational force,
the absorbent layer includes an end that has a weir portion on a side of the open end,
the weir portion protrudes inwardly with respect to a radial direction of the atmospheric passage member, and
the weir portion protrudes from the lower side with respect to the direction of gravitational force.

10. The canister module according to claim 1, wherein the volatile substance is fuel vapor.

11. A canister module that connects with a fuel tank, the canister module comprising:
a canister that accommodates an absorbent;
an atmospheric passage member that has a first end, which is capable of communicating with an atmospheric port of the canister, the atmospheric passage member having a second end that is capable of communicating with atmosphere, the fuel tank communicating with the atmospheric port of the canister through the absorbent accommodated in the canister; and
an absorbent layer that is arranged along an inner wall of the atmospheric passage member,
wherein the fuel tank communicates with the absorbent layer accommodated in the atmospheric passage member through the absorbent accommodated in the canister when the atmospheric passage member communicates with the atmospheric port of the canister.

12. The canister module according to claim 11, further comprising:
a drain valve that is capable of communicating the canister with the atmosphere through the atmospheric port, the drain valve being capable of blocking the canister from the atmosphere,
wherein the fuel tank communicates with the atmosphere through both the absorbent accommodated in the canister and the absorbent layer accommodated in the atmospheric passage member when the drain valve communicates the canister with the atmosphere.

13. A canister module that connects with a fuel tank and an intake pipe of an internal combustion engine, the canister module comprising:
a canister that accommodates an absorbent;
an atmospheric passage member that has a first end, which is capable of communicating with an atmospheric port of the canister, the atmospheric passage member having a second end that is capable of communicating with atmosphere, the fuel tank communicating with the atmospheric port of the canister through the absorbent accommodated in the canister; and
an absorbent layer that is arranged along an inner wall of the atmospheric passage member,
wherein the fuel tank communicates with the absorbent layer accommodated in the atmospheric passage member through the absorbent accommodated in the canister when the atmospheric passage member communicates with the atmospheric port of the canister, and
the intake pipe communicates with the absorbent layer accommodated in the atmospheric passage member through the absorbent accommodated in the canister when the following conditions are satisfied;
the intake pipe communicates with the canister; and
the atmospheric passage member communicates with the atmospheric port of the canister.

14. The canister module according to claim 13, further comprising:
a drain valve that is capable of communicating the canister with the atmosphere through the atmospheric passage member, the drain valve being capable of blocking the canister from the atmosphere;
wherein the canister communicates with the atmosphere through the drain valve when the internal combustion engine is stopped.

15. The canister module according to claim 14, further comprising:
a purge valve that is capable of communicating the canister with the intake pipe, the purge valve being capable of blocking the canister from the intake pipe;
wherein the atmospheric passage member and the canister communicate with the intake pipe through the purge valve when the internal combustion engine is stopped.

16. A method for absorbing volatile substance, the method comprising:
providing a canister and an atmospheric passage member, the canister accommodating an absorbent, the atmospheric passage member connecting with the canister, the atmospheric passage member being capable of communicating with atmosphere, the atmospheric passage member accommodating an absorbent layer that is arranged along an inner wall of the atmospheric passage member,
introducing volatile substance into the canister for absorbing volatile substance in the canister, and
introducing volatile substance from the canister into the atmospheric passage member for further absorbing volatile substance through the atmospheric passage member.

17. The method for absorbing volatile substance according to claim 16, further comprising:
introducing air into the atmospheric passage member for absorbing volatile substance, which is absorbed in the absorbent layer, into air.

18. The method for absorbing volatile substance according to claim 17, further comprising:
introducing air from the atmospheric passage member into an internal combustion engine through the canister.

19. A manufacturing method of a canister module, the method comprising:
inserting at least one absorbent layer into an atmospheric passage member from one of a first end of the atmospheric passage member and a second end of the atmospheric passage member such that the absorbent layer is arranged along an inner wall of the atmospheric passage member;
connecting one of the first end of the atmospheric passage member and the second end of the atmospheric passage member to a first component; and
connecting an other of the first end of the atmospheric passage member and the second end of the atmospheric passage member to a second component,
wherein the first component is one of a canister, which is adapted to accommodate an absorbent, a drain valve, which is capable of communicating and blocking the atmospheric passage member, and a filter, which is capable of removing foreign matters, and
the second component is an other of the canister, the drain valve, and the filter.
